(19) United States
(12) Patent Application Publication
(10) Pub. No.: US 2009/0275007 A1
(43) Pub. Date: Nov. 5, 2009

(54) System and Method for Strength Training

(76) Inventor: Sean P. Johnson, Littleton, CO (US)

Correspondence Address: SWANSON & BRATSCHUN, L.L.C., 8210 SOUTHPARK TERRACE, LITTLETON, CO, 80120, US

(21) Appl. No.: 12/432,619

(22) Filed: Apr. 29, 2009

Related U.S. Application Data
(60) Provisional application No. 61/049,037, filed on Apr. 30, 2008.

(51) Int. Cl. G09B 19/00

(52) U.S. Cl. 434/247

(57) ABSTRACT

A method of strength training that includes initiating eccentric contraction of a muscle of interest at a starting position where the muscle of interest is maximally flexed without losing contraction force or increasing the load on a joint. The method also includes eccentrically contracting the muscle of interest through a Contractile Reversal Phase up to a J-Point. When the J-Point is observed the method includes initiating concentric contraction of the muscle of interest to return the muscle of interest to the starting position.

### RELATED APPLICATIONS

This application claims priority from U.S. Provisional Patent Application Ser. No. 61/049,037, filed Apr. 30, 2008, entitled “System and Method for Strength Training,” which is hereby incorporated by reference.

### TECHNICAL FIELD

The present disclosure is directed toward a system and method for training, and more particularly toward a method where a beneficial range of muscle motion may be identified.

### BACKGROUND

There are two widely-accepted schools of thought concerning of the appropriate range of motion for strength training and exercise. The first of which is full range of motion. Full range of motion training is generally supported by the scientific community. Full range of motion training is defended by its advocates with EMG studies, theories such as reticular innervation, as well as selected interpretations of the muscular length-tension relationship. Full range of motion training is also premised upon the idea prevalent among many trainers that using a full range in training mimics the motions needed during sports competition and routine activity.

Alternatively, some trainers advocate training and exercise where the joint is moved to 90 degrees. Some physical therapists and trainers believe that a 90 degree technique keeps tension on the muscles at all times. Third method, which is no longer popular, involved the use of nothing but isometric contractions, defined as holding the body in a relatively fixed position rather than using dynamic motion during exercise. It has been shown however, that some movement of the joints is necessary to release synovial fluid. If some movement is present, the joints are protected by synovial fluid for a range of at least 15 degrees further on each end than the range of motion used. For this reason and others isometric contractions are not often the primary techniques used in modern training.

Electromyograms (EMG) are used to measure the innervation of a muscle. It is known in the scientific community that EMGs are an indirect method of measuring muscle contraction, since the relationship between the level of measured innervation and level of muscle contraction is not certain. Researchers draw theoretical conclusions about muscle contraction and range of motion based on EMG readings, but there is not sufficient evidence to rule out other possible explanations. This is true whether an invasive needle version of EMG or a non-invasive surface version of EMG is utilized. For example, low force contractions would primarily be caused from low threshold motor units. Low threshold motor units are believed to control only Type I muscle fibers. These fibers are slow twitch, non-glycolytic, oxidative fibers which are primarily used during weight training as stabilizers. The fiber types used for primary movements in the weight room or during other training or exercise are Type IIa and Type IIb muscle fibers. Type IIa fibers can contract up to 60 times per second and are glycolytic and oxidative. Type IIb fibers can contract up to 120 times per second and are glycolytic and non-oxidative. Theories about appropriate exercise and training range of motion in the fitness industry tend to assume that EMG studies assess the activity of Type II fibers based on the size principle; slow twitch motor units must be recruited before fast twitch, and thereby these studies are believed to determine a range of motion in relation to EMG readings.

One such theory, the Reticular Innervation theory, states that at the point in time when an agonist (a prime muscle mover such as the biceps brachii in a biceps curl) is in the most lengthened position with the point of insertion furthest from the origin, electrical energy is stored in the antagonist (an opposing muscle such as the triceps brachii in a biceps curl) then transferred to allow the prime mover to have an optimal contraction when going back into the concentric portion of the movement.

Thus, Reticular Innervation theory and the length-tension relationship are used to explain EMG results: the amount of contractions based on EMG readings changes from very little contraction at the shortest length, towards a greatest contraction ability in the middle length, then back to very little contraction possibility at the longest length. Unfortunately, this theory does not compensate for the effect of an EMG recording only “action potentials” (nerve impulses) rather than the activation of myofilaments or actual contractile potential at different positions within the range of motion. Changes in fiber length affect the innervation levels as well. The Reticular Innervation theory is also attempting to explain why EMG studies read the most activity with a fast eccentric movement immediately followed by a quick concentric movement, with no pause at the static transition. Thus, the faster someone moves, the more innervation is measured.

Generally speaking, research studies tend to examine movements that change the moment arm throughout a lift or other exercise. The “moment arm” as used herein and generally in the biomechanical arts is a term describing the distal distance from the fulcrum, the moving joint, to the resistance (in the case of weight training, the weight being lifted). For example, when one performs a biceps curl with his or her elbows stationary and slightly in front of the shoulders in the sagittal plane, in front of the body in this case, his or her moment arm is very small at the “bottom” of the motion, assuming the participant is using a full range technique whereby the elbow joints are at an angle greater than ninety degrees. The moment arm is greatest just after the middle of the contraction; and finally, as the participant continues bringing the weight up, the moment arm shortens again at the top of the concentric contraction.

Because of the shifting of the moment arm throughout the movement, it becomes increasingly difficult to measure the actual force on the prime mover at different positions of a particular contraction. General biomechanical principles dictate that the force on the prime mover would increase as the moment arm increases. This would give reason for there being more innervation measured when the moment arm is longer (i.e., in the middle of the range, in the example of a biceps curl) as compared to when the moment arm is shorter in distance, specifically at the top and bottom of the range. As noted by Barak et al. (2006), “As a result of a change in knee angle, the magnitude of the EMG signal during maximal voluntary efforts, will change as the length of the activated muscle fibers increases.” Barak Y, Avalon M, Dvir Z: “Spectral EMG changes in vastus medialis muscle following short range of motion isokinetic training.” J Electromyogr Kinesiol. 2006 October; 16(5):403-12. Although research like this offers alternate explanations for the spike in EMG-measured innervation appearing in the middle of the range, researchers thus far have tended to interpret the spike as a maximum of both innervation and muscle contraction.

Known EMG studies of knee extensions have also relied upon contraction length-tension explanations for the observed data. At the bottom of typical knee extension the moment arm is at its shortest distance, and as the contraction moves concentrically into a shorter muscle position the moment arm increases all the way to the full contraction point. It may be noted that typical EMG results show the least amount of innervation at the top of the movement, when the muscles were contracted the most, and the moment arm was the largest. As the individual trainee moved his or her knee further into eccentric contraction, with the moment arm decreasing and the muscle contractions moving away from each other, the EMG reads an increase in innervation. Once again, the conflation of EMG-measured innervation and contractile potential may have led researchers to believe that the strongest contraction appears in the middle of the range. A higher level of measured innervation is plausible, taking into account the EMG distortion noted above, the effect of moment arm, and the effect of greater per fiber intensity as the number of contracting fibers decreases during eccentric motion. This conclusion however does not necessarily correspond to greater muscle contraction.

In the shortest concentric contraction of any given muscle, the maximum number of fibers are contracting to support weight. It is probably not necessary for each fiber to contract at its maximum intensity (120 contractions/second) in this position. For example, if 100% of the prime mover muscle's Type IIb muscle fibers are contracting at 33% intensity, the average would be 40 contractions per fiber per second. This is a strong position of high contractile potential, easily generating enough force to hold typical weight. However, due to the relatively low fire rate, this position is generally read as low innervation on an EMG and is usually interpreted as low in contractile potential. As an individual moves into eccentric contraction the fibers release most of their contractions, increasing the need for each remaining contracting fiber to do so at a higher intensity. For example, if only 70% of the Type IIb fibers of a given muscle are contracting, the intensity of each might jump closer to 100% (i.e., 120 contractions per second). These fibers must experience an increase in contraction rate to reduce extra pressure on joint(s). Depending on load and the extent to which the number of contracting fibers has diminished (i.e., how far “down” in eccentric contraction one has gone), it may not be possible for increased intensity to compensate for the decreasing number of muscle fibers able to contract. Pressure will at this point transfer to the joint(s). Unfortunately, researchers explaining the data with current length-tension theories often recommend full-range lifting techniques, believing that areas of highest innervation correspond to areas of most productive muscle contraction.

Another reason advanced in favor of full range of motion training is that sports or other activities utilize a full range of motion, and if participants are not trained with a full range of motion they will have more of a chance of injury. But when one increases the strength of a muscle (regardless of exercise range), one increases its ability to work at any point in its range of movement (See Barak Y, Avalon M, Dvir Z: “Spectral EMG Changes in Vastus Medialis Muscle Following Short Range of Motion Isokinetic Training.” J. Electromyogr. Kinesiol. 2006 October; 16(5):403-12). Exercising in a full range is not necessary to strengthen muscles, stabilize joints, and decrease the risk of injury. Actually, since full range of motion weight training increases joint load with every repetition, it is conceivable that despite gains in muscle mass, full range gradually harms joints and makes them more susceptible to injury. Sports in which players do go through a full range of joint motion correlate with the highest statistics of injuries. For example, in golf 1 in 3 golfers will hurt their back or shoulder every 3 years; in baseball, pitchers experience injuries often requiring multiple shoulder surgeries; in tennis, rotator cuff tears are common; in bowling, ball curving requires full range from supination to pronation, which causes many wrist injuries. There were 80,000-90,000 ACL injuries in athletes in the United States in 1996. Some of these injuries may have been directly caused or preceded by training in the weight room over a full range of motion, which arguably weakens the joints.

Using a ninety degree angle range of motion for training with two bones selected to determine the ninety degree range has been adopted by many trainers. Ninety degree range of motion training is advanced upon the theory that the training individual will keep tension on the relevant muscle throughout the ninety degree range. Any lift using the humerus bone with the ulna, or the femur and the tibia can be measured easily to the ninety degree angle. Considering the biomechanics of this methodology one can see that any pressing motion above the ninety degree angling would result in an easier angle to utilize the muscular leverage system to pull the bones back to the fully contracted position. Anything below a ninety degree angle would put the lifter at an increasingly difficult angle making it more difficult to utilize the leverage system to contract the relevant muscles and pull the bones back. During ninety degree range of motion training the subject may believe the relevant muscle is under tension the entire time. However, this is not necessarily the case. Depending upon the exercise and the individual, ninety degree training can also lead to joint strain and possible long-term injury, similar to the aforementioned risks of full range training.

The present invention is directed toward overcoming one or more of the problems discussed above.

### SUMMARY OF THE EMBODIMENTS

One embodiment is a method of strength training that includes initiating eccentric contraction of a muscle of interest at a starting position where the muscle of interest is maximally flexed without losing contraction force or increasing the load on a joint. The method also includes eccentrically contracting the muscle of interest through a Contractile Reversal Phase up to a J-Point. When the J-Point is observed the method includes initiating concentric contraction of the muscle of interest to return the muscle of interest to the starting position.

The method of strength training features various techniques for observing the J-Point. For example, the J-Point may be observed by observing an increase in muscle tension during the eccentric contraction of the muscle of interest and identifying the point in the eccentric contraction of the muscle of interest where the increase in muscle tension stops. Alternatively, the J-Point may be observed by visually identifying the point in the eccentric contraction of the muscle of interest where a sudden change in apparent shape of the muscle of interest occurs. For example, the J-Point may be observed by visually identifying the point in eccentric contraction of the muscle of interest where the apparent shape of the muscle of interest flattens at an accelerated rate of speed.

In addition to the above-described methods of visually observing the J-Point, the J-Point may be identified by touch. For example, the J-Point may be observed by externally palpating the head of the muscle of interest to feel increased tension during the eccentric contraction of the muscle of interest and externally palpating the head of the muscle of interest to feel the point in the eccentric contraction where the increase in muscle tension stops. Alternatively, the J-Point may be observed by externally palpating the head of a synergist muscle to feel the point in the eccentric contraction of the muscle of interest where muscle tension in the synergist rapidly decreases.

An alternative embodiment is a method of coaching a participant in a strength training exercise. The coaching method includes directing a participant to employ one or more aspects of the method of strength training detailed above. The participant may be a trainee or another strength trainer, physician, physical therapist, coach or other provider of physical training or therapeutic services and the method may further include teaching the participant how to instruct third parties in the described methods of strength training.

### BRIEF DESCRIPTION OF THE DRAWINGS

FIG. 1 is a schematic diagram of the phases of eccentric contraction.

FIG. 2 is a schematic diagram of the phases of eccentric contraction.

FIG. 3 is a flow chart representation of a training or coaching method.

### DETAILED DESCRIPTION

In weight training or other strength exercise, at the end of concentric motion and beginning of eccentric motion, it is well-known and accepted that the muscle of interest is contracted. Conversely, if one were to continue the eccentric motion to the point where the relevant joint can move no further, the muscle of interest would be better characterized as stretching. Although this “stretch” does not prevent the muscle fibers of the muscle of interest from contracting, the number of possible contractions is greatly diminished. Therefore, eccentric motion can be characterized as moving from a “flex” toward a “stretch”—from a position of high contractile potential toward a position of such low contractile potential that the muscle of interest is capable of producing relatively little force. The scientific community's primary means of studying what occurs between the “flex” and “stretch” has long been EMG (electromyography) machines, which measure electrical activity in the muscle of interest. Unfortunately, the precision of these machines is not adequate to correlate “electrical activity” with the “muscle contractions” desired during resistance or other strength training. As noted by Roger M. Enoka, Ph.D., and Andrew J. Fuglevand, Ph.D., 2001, “Motor unit territory can be determined from scanning electromyography (EMG), which involves inserting a concentric needle electrode deep into the muscle and then extracting it in 50-μm steps while making recordings that are triggered from a single-fiber electrode. Similarly, fiber density can be determined from the number of action potentials detected with a single-fiber electrode that has a known detection area. Such an approach, however, is limited to low-force contractions and has produced rather low innervation ratios.” (cite) As recently as 2008, Gordon R. Chalmers notes in sports Biomechanics, January 2008; 7(1): 137-157, “In summary, while some data suggest that surface EMG power spectrum analysis could be a convenient, noninvasive way to study motor unit recruitment, the articles reviewed do not support this technique as a valid method to assess recruitment or the activity of specific fibre types during contractions, especially when changes in muscle length or force occur.” (cite) The authors then conclude, “The techniques using surface EMG or mechanomyographic power spectrum frequency or amplitude analysis do not currently have the ability to identify the activity of fast versus slow motor units during a contraction, particularly when muscle length varies.” Despite theories about reticular innervation, it is likely that traditional weight-lifting technique (known as “full range of motion”) ends the eccentric motion in a “stretched” position, where relatively few fibers of the muscle of interest can contract.

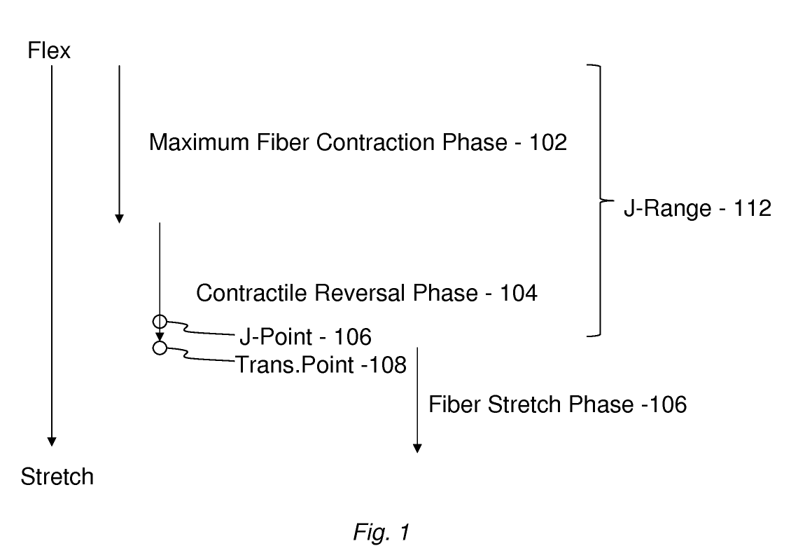

The training and coaching methods disclosed herein include the identification of a new, dynamic point in the range of motion at which eccentric contraction should be stopped. In order to describe this point, it is useful to begin by dividing the total possible range (from maximum “flex” to maximum “stretch”) into three basic phases. As shown in FIG. 1, the first eccentric contraction phase is the Maximal Fiber Contraction (MFC) Phase 102, defined herein as the eccentric muscular contraction phase, where the muscle of interest is felt to have the highest percentage of muscle fibers contracted, and during which the lowest amount of contractile potential per mm of eccentric motion is lost. The Maximal Fiber Contraction Phase 102 is followed by the Contractile Reversal Phase (CRP) 104, defined herein as the eccentric muscular contraction phase, where the loss of contractile potential in the muscle of interest is felt to “speed up.” This phase is accompanied by a greater loss of contractions per mm of eccentric motion than the average loss during the MFC phase, and said loss proceeds in an apparently linear manner. The final phase, the Fiber Stretch Phase (FSP) 106, defined herein as the phase of eccentric muscle contraction, during which the muscle of interest is felt to be “stretched,” requiring “help” from other force vectors, levers, synergists if available, as well as other methods of transference (joint torque) in order to continue motion to move a weight, concentrically or eccentrically.

It is important to note that these three phases will correspond to vastly differing ranges of motion in different muscle groups and among different populations dependent upon numerous factors. The most crucial phase to recognize with respect to the disclosed methods of training or coaching is the Contractile Reversal Phase 104. The CRP 104 will differ with each individual and the individual's strength conditioning level. The CRP 104 includes the transition from the last moments of what feels like and can be described as a “full contraction” to the first moments of what feels like and can be described as a “stretch.” At a determinable position within the Contractile Reversal Phase 104, (differing with each individual), one comes abruptly to the J-Point 108, defined herein as the point in the CRP 104 of eccentric contraction where the muscle of interest cannot handle the resistance applied without transferring load to other muscles or joints in the body assuming eccentric motion continues. Since the exact position of the J-Point 108 in a range of motion depends upon how much resistance the muscle of interest must handle, this point will also vary depending on how much weight is used, but it is always located between the start of the Contractile Reversal Phase 104 and the Transference Point 110, as defined below.

The disclosed coaching and training methods are practical methods of teaching students to stop eccentric muscular contraction just before reaching the Transference Point 110, which is the first unsafe position in an eccentric contraction where the muscle of interest has transferred a significant amount of resistance to other muscles and joints. The target position of training is the J-Point 108. When the subject is trained properly to be able to “feel” the start of the Contractile Reversal Phase 104, he or she will also be able to “feel” the J-Point 108 as the last point of contractile potential before reaching the Transference Point 110. The J-Range 112, is defined herein as working from the furthest available concentric contraction, without losing contraction force or increasing load on a joint, to however close to the J-Point 108 the practitioner or the subject can locate. The more a subject is trained to increase his or her sympathetic ability to feel the contractions, the closer he or she will be able to locate the J-Point 108, without having to worry about extending to the Transference Point 110.

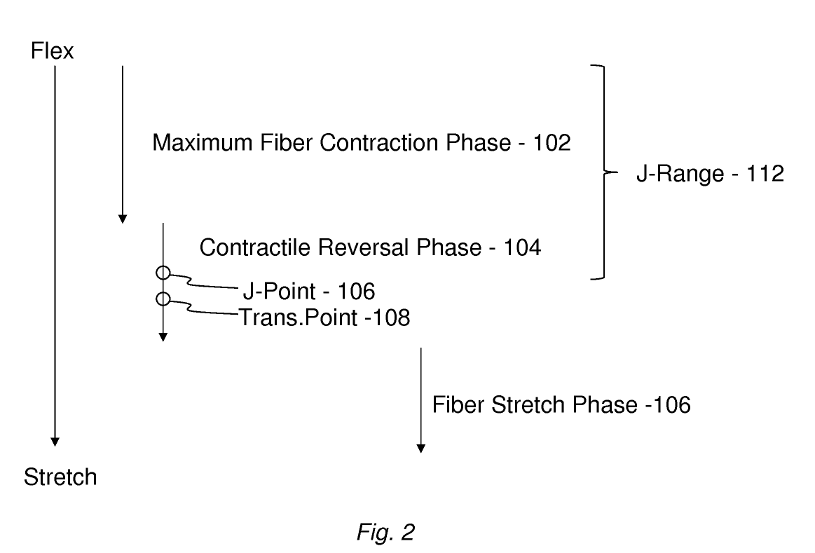

The diagram of FIG. 1 is a schematic illustration of the phases of eccentric contraction as discussed above. The relative length or duration of the three phases will be different in each individual; no attempt has been made to draw any phase of contractile motion to scale. As shown in FIG. 2, it is important to note that the J-Point 108 is dependent on load. Therefore the Transference Point 110 could be towards the beginning of the Contractile Reversal Phase 104, but always after the J-Point 108.

### DEFINITIONS

Shortening contraction/increasing force output theory—The theory that from a fully lengthened position to a fully shortened position with any given agonist, the contractile potential of said agonist will increase in a non-linear manner (more increase per distance at some times, less at other times, but always increasing). Thus, at the shortest position of the agonist is where there occurs the highest contractile potential. At the longest position of the agonist there occurs is the lowest contractile potential. This can be shown with a transversus abdominis (transverse) “drawn in” maneuver during a plank (also called prone isometric transversus abdominis) exercise utilizing constant leverage angle, moment arm, and force. When the transverse is drawn in, and the hips are slightly elevated, the subject can last longer before transferring load to the next available synergist, the erector spinae group, than when the transverse is contracted but in a more lengthened position. Drawing the transverse in while lifting the hips shortens the fibers to the shortest position of all abdominal muscles.

Maximal Fiber Contraction Phase—The phase in a range of motion where the muscle fibers are in the most optimal positions for the Z-lines to respond to innervation with the majority of the given muscle fibers.

Contractile Reversal Phase—The dynamic phase after the Maximal Fiber Contraction Phase to one degree past the J-Point where the fibers “feel” and/or “look” as if they are speeding up the loss of fiber contractions at a relatively quick pace. The J-Point can be found directly with the Sympathetic Awareness Method, Palpation Method, or indirectly with the Indirect Visual Method and/or the Synergist Method as described below.

J-Point—A dynamic point that is the furthest point in the Contractile Reversal Phase that a subject can safely maintain muscle fiber contractions without over-stressing minimal fibers, or reaching the Transference Point. To date, the J-Point has been observed anywhere from 15 degrees to 155 degrees away from the full concentric contraction depending on the individual and exercise.

Over-Stressing Minimal Fibers—The theory that increasing movement past the identified J-Point will decrease the number of fibers actually contracting against a given resistance, while generally increasing the load on the fewer fibers, since a synergist cannot handle the same force as the larger agonist.

Transference Point—Immediately after the J-Point, the Transference Point marks beginning of the fiber stretch phase over-stressing minimal fibers takes place, while transferring the load of a given resistance off of the initial agonist onto other synergists, when available, as well as to the joints.

Fiber Stretch Phase—The phase in the full range of motion past the Transference point during a lengthening contraction, to the fully lengthened position. During this phase, there are too few contractile potentials to handle the applied load since many of the Z-lines are too far away to properly respond to innervation, causing over-stressing of minimal fibers to occur under resistance.

J-Range—The most efficient dynamic range of training muscles with resistance from fullest safe agonist contraction to the closest to the J-Point as practitioner and/or subject can locate.

Sympathetic Awareness Method—A method of using the subject's ability to focus on his or her own muscle fiber contractions to determine where in a full range of motion the joint and relevant muscles are positioned (i.e. Maximal Fiber Contraction Phase, J-Point, Contractile Reversal Phase, Transference Point, Fiber Stretch Phase). A practitioner of the method will, with practice, be able to feel active muscle fibers decreasing in number in the relevant muscle tissue up to the J-Point where a sudden increase in tension occurs. During exercises with limited resistance designed to teach the methods disclosed herein, a relaxation of the muscle tissue at the Transference Point may be felt as well.

Indirect Visual Method—A method of visually assessing the J-Range by muscle characteristics. When the agonist is fully shortened (Maximal Contraction), it bunches up and appears bulkier. Usually the J-Point can be indicated by the sudden change in the muscle's apparent shape, where it will flatten at a faster rate of speed than observed during the rest of the movement in the Maximal Fiber Contraction Phase.

Palpation Method—A method of touching externally the muscle head to “feel” when the muscle fibers are transitioning from Maximal Contraction, through the Maximal Fiber Contraction Phase, through the Contractile Reversal Phase up to optimally the J-Point. As this progression occurs, decreasing recruited fibers will be observed up to the J-Point where a sudden increase in muscle tension will be observed. Either subject or practitioner can use this method without resistance to “feel” the release of tension which occurs in the palpated muscle tissue past the J-Point at the Transference Point in order to heighten the awareness for the subject.

Synergist Method—An indirect method of a practitioner palpating the subject's synergist to “feel” when the synergist suddenly loses a significant amount of its contraction. This moment corresponds to the “emergency” increase of contractions to the prime mover right before pressure goes largely back to synergists and also onto tendons and joints. The Synergist Method can be used to “double check” another method, or in place of another method under certain conditions with the subject.

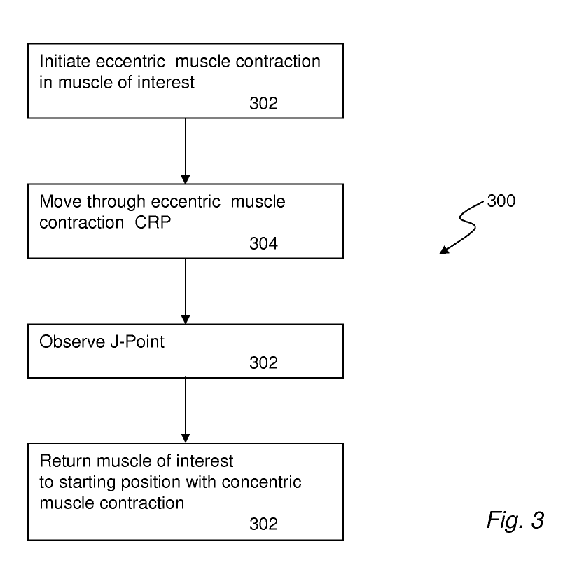

One embodiment disclosed herein is a method of strength training as shown on the flow chart of FIG. 3. The method of strength training 300, includes initiating eccentric contraction in a muscle of interest at a starting position where the muscle of interest is maximally flexed but not losing contraction force on increasing the load on a joint (step 302). It should be noted that the method may be performed by one engaged in strength training. Alternatively, the method may be rendered by coaching a participant or teaching a coach how to direct a participant in strength training exercises as disclosed herein.

After the initiation of eccentric contraction, the participant will, or will be directed to eccentrically contract the muscle of interest through a Contractile Reversal Phase (step 304). Eccentric contraction will continue until the J-Point is observed (step 306). Upon observing the J-Point, the trainee will, or will be directed to initiate concentric contraction of the muscle of interest to return the muscle of interest to the starting position (step 308).

The foregoing generalized strength raining or strength coaching framework may be applied to any muscle group. Selected specific exercises are described in detail below. It is important to note that the exercises described in detail are non-limiting. The techniques disclosed here in may be applied to any exercise which involves the strength training of a muscle or muscle group over a possible range of motion.

### Individual Exercises:

Squats: From the proper starting position (standing with knees slightly bent (not locked), weight on heels), lower weight in elevation at a rate of speed conducive to feeling the fiber contractions. Palpations from subject or practitioner may be used if subject does not posses strong sympathetic nervous system awareness of fiber contractions (not nociceptors). Feel or observe using one of the methods described above the head of any superior quadriceps femoris prime mover (preferably vastus lateralis and vastus medialis, simultaneously). Move down in elevation through the contractile reversal phase until the prime movers suddenly bulge to their largest sizes, thus identifying the J-Point; then pause, and move back up to a full concentric contraction, standing nearly straight again but stopping before locking the knees (that is, before force starts to shift off of the quadriceps onto the knee joint (PCL)). This is one repetition of motion within the J-Range.

Motion anywhere below the J-Point during a squat will transfer extra force to other synergists; i.e. the hamstrings (biceps femoris, semitendinosus, semimembranosus) and gluteals (mostly the gluteus maximus), while other stabilizers increase their contractions in an attempt to keep from excessive joint pressure, which is not ultimately possible. Since all heads of the quadriceps femoris attach into the patella, the muscles act as a leverage stabilizer preventing force load on the joint ligaments and cartilage. After the J-Point is surpassed in the range of motion, the described muscles no longer can serve the full stabilization purpose, therefore increasing ligamentous, i.e. the anterior crucient ligament and cartilage pressure. The joint then must torque, while the overloaded synergists strain in order to get the fibers back into the safe J-Range, where the muscle system can resume optimal action.

If the subject is in a harmful position, such as a full squat, a natural reflex is to get the body out of the damaging position immediately. This means that transference of stress and torque to joints in a harmful way will not typically override the instinct for getting the body out of the harmful state. Accordingly, muscles will enter a condition known as synergistic dominance in, for example, a harmful full squat position. Over time, synergistic dominance can become a trained condition to the detriment of the muscle system as a whole.

Chest Press: Starting with elbows slightly bent, lower the weight through the maximal fiber contraction phase, through the start of the contractile reversal phase while “feeling” (either through palpation or sympathetic ability) the pectoralis major muscle on the muscle head (with female or uncomfortable subjects the practitioner may feel the triceps brachii, or use the indirect visual method to find the approximate J-Point). Stop the eccentric contraction as close to the J-Point as can be efficiently located, return to the full contraction concentrically, stopping just before the lock of the elbows.

The J-Point with the chest press can also be located by the subject with guidance, simply by having the subject place one of his or her hands on the opposite side's chest muscle, then with the free arm extended out into a full contraction, very slowly simulating the chest press movement (including a contraction) in order to feel when to stop. Experience of subject is not a factor in ability to “feel” the Contractile Reversal Phase using a self palpation method without resistance. The subject can then find his or her J-Point based on when he or she feels like the fibers are going to stretch more than contract. Alternately, this method can involve the subject safely contracting to the Transference Point to better find where his or her individual Contractile Reversal Phase is located. The subject can then have a better understanding of when he or she is close to their J-Point, and safely go to that angle while performing the exercise. It is important to note, however, that the actual J-Point will vary based on load. The J-Point position can change based on flexibility or neurological, or other inhibitory effects.

Latissimus Dorsi Pulls: Start with the bar or handles down at about chin level, in a full concentric contraction before the coracoid process is pulled forward by the pectoralis minor and the shoulders roll forward. Move the bar or handles up in elevation through the Maximal Fiber Contraction Phase, through the start of the Contractile Reversal Phase while feeling the latissimus dorsi muscle get as close to the J-Point as efficiently as can be located, pause, then move back towards the full contraction concentrically.

### Methods of Identifying the J-Point:

Visual—The examiner, coach, or trainer can view the largest working prime mover and determine subjectively when said muscle is starting to release its contraction. The examiner then instructs the individual to stop eccentric contraction when the aforementioned point is reached.

Third-Person Tactile—The examiner, coach, or trainer can place his or her fingertips, when appropriate, on the largest working prime mover and feel when said muscle starts to bulge (overload with intensity), right before releasing the majority of its contractions. Alternately, the examiner, coach, or trainer can place his or her fingertips on the largest synergist to the prime mover and feel when said muscle suddenly loses the majority of its contractions. The examiner can then inform the individual to stop when the J-Point is reached.

First-Person Kinesthetic Awareness—If the individual can consciously feel the largest working prime mover's contractions, he or she can become aware of the feeling when the muscles are just beginning to lose their full contractions (when the sarcomeres are inhibited from keeping their closest-to-T-line position), and stop the eccentric contraction at this, the J-Point.

Since J-Point/J-Range Training completely circumvents any position that puts excessive pressure on joints, athletes and participants utilizing this type of training will suffer fewer and less extensive injuries than those who strain their joints by working out with an unnecessarily large range of motion. Long-term lifting will no longer be associated with joint injury and nagging pain. People will get more efficient workouts, saving time as well as increasing the longevity of their joints.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference. The disclosure also encompasses all possible permutations of the claim set, as if they were multiple dependent claims.

Various embodiments of the disclosure could also include permutations of the various elements recited in the claims as if each dependent claim was multiple dependent claim incorporating the limitations of each of the preceding dependent claims as well as the independent claims. Such permutations are expressly within the scope of this disclosure.

What is claimed is:

1. A method of strength training comprising:
initiating eccentric contraction of a muscle of interest at a starting position where the muscle of interest is maximally flexed;
eccentrically contracting the muscle of interest through a contractile reversal phase up to a J-Point;
observing the J-Point; and
upon observing the J-Point, initiating concentric contraction of the muscle of interest to return the muscle of interest to the starting position.

2. The method of strength training of claim 1 wherein the J-Point is observed by:
observing an increase in muscle tension during the eccentric contraction of the muscle of interest; and
identifying the point in the eccentric contraction of the muscle of interest where the increase in muscle tension stops.

3. The method of strength training of claim 1 wherein the J-Point is observed by visually identifying the point in the eccentric contraction of the muscle of interest where a sudden change in the apparent shape of the muscle of interest occurs.

4. The method of strength training of claim 3 wherein the J-Point is observed by visually identifying the point the point in the eccentric contraction of the muscle of interest where the apparent shape of the muscle of interest flattens at an accelerated rate of speed.

5. The method of strength training of claim 1 wherein the J-Point is observed by:
externally palpating the head of the muscle of interest to feel increased tension during the eccentric contraction of the muscle of interest; and
externally palpating the head of the muscle of interest to feel the point in the eccentric contraction of the muscle of interest where the increase in muscle tension stops.

6. The method of strength training of claim 1 wherein the J-Point is observed by externally palpating the head of a synergist muscle to the muscle of interest to feel the point in the eccentric contraction of the muscle of interest where muscle tension in the synergist rapidly decreases.

7. A method of coaching a participant in strength training exercise comprising:
directing the participant to initiate eccentric contraction of a muscle of interest at a starting position;
directing the participant to eccentrically contract the muscle of interest from the starting position through a contractile reversal phase up to a J-Point;
observing the J-Point or directing the participant to observe the J-Point; and
upon observing the J-Point directing the participant to initiate concentric contraction of the muscle of interest to return the muscle of interest to the starting position.

8. The method of coaching a participant in strength training exercise of claim 7 wherein the J-Point is observed or the participant is directed to observe the J-Point by:
observing an increase in muscle tension during the eccentric contraction of the muscle of interest; and
identifying the point in the eccentric contraction of the muscle of interest where the increase in muscle tension stops.

9. The method of coaching a participant in strength training exercise of claim 7 wherein the J-Point is observed or the participant is directed to observe the J-Point by visually identifying the point in the eccentric contraction of the muscle of interest where a sudden change in apparent shape of the muscle of interest occurs.

10. The method of coaching a participant in strength training exercise of claim 9 wherein the J-Point is observed or the participant is directed to observe the J-Point by visually identifying the point the point in the eccentric contraction of the muscle of interest where apparent shape of the muscle of interest flattens at an accelerated rate of speed.

11. The method of coaching a participant in strength training exercise of claim 10 wherein the J-Point is observed or the participant is directed to observe the J-Point by:
externally palpating the head of the muscle of interest to feel increased tension during the eccentric contraction of the muscle of interest; and
externally palpating the head of the muscle of interest to feel the point in the eccentric contraction of the muscle of interest where the increase in muscle tension stops.

12. The method of coaching a participant in strength training exercise of claim 7 wherein the J-Point is observed or the participant is directed to observe the J-Point by externally palpating the head of a synergist muscle to the muscle of interest to feel the point in the eccentric contraction of the muscle of interest where muscle tension in the synergist rapidly decreases.

13. The method of coaching a participant in strength training exercise claim 7 wherein the participant is a strength trainer, physician, physical therapist, coach or other provider of physical training or therapeutic services and the method further comprises teaching the participant how to instruct third parties in the method of strength training.
